(19) United States
(12) Patent Application Publication
(10) Pub. No.: US 2011/0049163 A1
(43) Pub. Date: Mar. 3, 2011

(54) Copper Lined Mixing Bowl

(75) Inventor: Bruce W. Perry, Canonsburg, PA (US)

(73) Assignee: ALL-CLAD METALCRAFTERS LLC, Canonsburg, PA (US)

(21) Appl. No.: 12/873,375

(22) Filed: Sep. 1, 2010

Related U.S. Application Data
(60) Provisional application No. 61/239,078, filed on Sep. 2, 2009.

(51) Int. Cl. A47J 47/00

(52) U.S. Cl. 220/573.1

(57) ABSTRACT

A mixing or beating bowl comprising a drawn shape of a bonded composite containing a layer of copper defining an interior surface of the bowl and a layer of a second metal defining an exterior surface of the bowl.

### CROSS-REFERENCE TO RELATED APPLICATION

This application claims priority to U.S. Provisional Application No. 61/239,078 filed Sep. 2, 2009, which is incorporated by reference herein in its entirety.

### BACKGROUND OF THE INVENTION

1. Field of the Invention

The present invention relates generally to kitchenware and, more particularly, to a composite copper lined mixing or beating bowl.

2. Description of Related Art

It is known in the culinary art that when egg whites are beaten, the type of bowl makes a difference. Cooks have found that when stainless steel or glass bowls are used, it is necessary to add cream of tartar to the egg whites in order to obtain the desired fluffy, high rise beaten whites. It is also known that the same desired results can be obtained without adding the cream of tartar if a copper mixing bowl is used. It is believed that copper reacts chemically with egg whites to provide the sought-after fluffy, high-volume egg whites. Apparently, a copper ion reacts with the egg white protein conalbumin to form a more stable foam and helps the egg white to retain moisture.

Egg whites are usually beaten or whipped with a hand-held whisk, a hand-held mixer, or a stand mixer. In order to withstand the impact of the beaters and resist denting, copper bowls must have sufficient wall thickness. This necessarily adds to the weight and cost of a copper mixing bowl. For example, a 7-quart copper mixing bowl is currently far in excess of $200.00.

Accordingly, there is a need for a copper mixing bowl that is lightweight, less costly, and yet is strong enough to resist denting

### SUMMARY OF THE INVENTION

The present invention provides a copper mixing bowl suitable for beating fluffy, high-rise egg whites comprising a composite bowl having an inner layer of copper bonded to an outer layer of another metal, such as stainless steel. The layers of copper and stainless steel are relatively thin to save on weight and cost while the stainless steel outer layer provides strength to resist denting during use. Such mixing bowls are also commonly referred to in the culinary art as “beating bowls” or “whipping bowls”. As used herein, the term “mixing bowl” includes these other terms.

### BRIEF DESCRIPTION OF THE DRAWINGS

FIG. 1 is a side elevation view of the bowl of the present invention;

FIG. 2 is a cross-sectional view of the side wall of the bowl taken at section II of FIG. 1 and FIG. 3; and

FIG. 3 is a plan view of the bowl of the present invention.

### DETAILED DESCRIPTION OF THE INVENTION

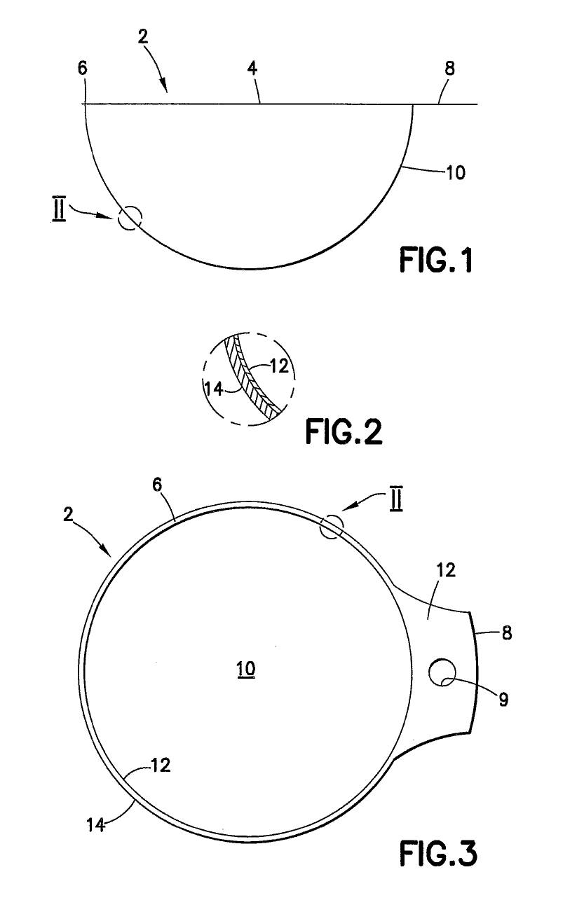

The mixing bowl 2 of the present invention is shown in side view in FIG. 1 of the drawings. The bowl 2 has an open top edge 4 with a flange, bead, rolled, or sheared edge 6 therearound which may flare outwardly a greater distance at one location to define a gripping portion or handle 8. The handle 8 may have a hole 9 or slot formed therethrough to receive a hook for hanging on a pot rack, if desired. The bowl side wall 10 is preferably in the shape of a hemisphere for ease of mixing or whipping by repetitive circular motion with a whisk, for example. The handle 8 is grasped by the user to stabilize the hemispherically shaped bowl 2 during use.

The composite bowl 2 has a layer 12 of copper bonded to a layer 14 of stainless steel, FIG. 2. The copper layer 12 defines the inside surface of the mixing bowl 2 and, as such, will contact the egg whites during beating/whipping. The stainless steel layer 14 defines the exterior of the bowl. The copper layer 12 is made from a relatively pure grade of copper or copper alloy, while the stainless steel is preferably a 300 grade or 400 grade. A type 304 grade of stainless steel is particularly suitable because it is easily deep drawn, buffs to a high luster, will retain its beauty during use, and is relatively easy to clean. Forming the bowl hemispherical sidewall 10 by spinning may also be possible.

Briefly stated, several desirable traits of the mixing bowl 2 of the present invention are: (a) fabrication from a thin layer 12 of copper to provide the desired reactive effect with egg whites and the like; (b) spherical shape 10 for ease of mixing or whipping by repetitive circular motion; (c) an integral holding handle 8 to stabilize the spherical shape during use; and (d) a composite side wall construction of sufficient thickness to avoid impact damage during use, handling or storage.

As discussed hereinabove, copper is an expensive and highly reactive metal which oxidizes and discolors very easily. It is also soft and prone to impact damage and scratching. The present invention employs a bonded metal composite consisting of a layer of copper 12 bonded to a layer of another metal such as stainless steel 14 for the construction of such a mixing bowl. The bowl construction of the invention offers the following advantages over traditional copper mixing bowls: (a) the stainless layer 14 provides strength, scratch resistance and cosmetic beauty; (b) the contrast in colors of the copper interior and stainless steel outer surface is an appealing cosmetic feature; (c) the bowl 2 can be made somewhat lighter than a solid copper bowl because of the superior strength of the stainless steel, offering manufacturing cost advantages as well as improved ease of handling; and (d) the stainless steel exterior is easily cleaned and cared for as opposed to the conventional copper exterior, which is maintenance intensive.

Example: A 14-inch disc of a copper/stainless steel roll/pressure bonded composite has a total thickness of 0.040″. The copper layer 12 is 0.010″ thick and the stainless steel layer 14 is 0.030″ thick. The disc is drawn by popularly known press forming technique, such as by hydroforming, into a 10-inch diameter drawn hemispherical shape 10 with the copper layer 12 on the interior surface of the shape. The flange of the bowl 2 is formed at the open edge 6 after drawing and the interior and exterior are polished. The handle 8 is trimmed after drawing and may have a hole 9 (FIG. 3) or slot formed therethrough for hanging the bowl 2 from a hook when not in use. In this embodiment, the handle 8 is integral with the bowl and is in the form of an elongated flange outwardly extending from the open edge 6 of the bowl. The upper surface of the handle 8 in this embodiment shows the copper layer on its upper surface and the stainless steel layer on its lower surface. Of course, other handles could be employed, such as a U-shaped pot handle riveted to the sidewall of the bowl or a ring-shaped handle could be pivotally mounted in a bracket attached to the bowl sidewall, to mention a few.

It will be understood that the bonded composite metal sheet for forming the bowl 2 can be made from a layer of copper 12 bonded to another metal other than the herein described preferred stainless steel layer 14. Metals such as aluminum or carbon steel could be substituted in forming the exterior layer as long as they are strong enough to support the thin layer of copper (and bondable thereto) and resist denting, etc. The exterior layer of aluminum can be anodized and the carbon steel layer could be coated with enamel or other material to enhance the appearance of the bowl.

While specific embodiments of the invention have been described in detail, it will be appreciated by those skilled in the art that various modifications and alternatives to those details could be developed in light of the overall teachings of the disclosure. The presently preferred embodiments described herein are meant to be illustrative only and not limiting as to the scope of the invention which is to be given the full breadth of the appended claims and any and all equivalents thereof.

The invention claimed is:

1. A mixing or beating bowl comprising a bonded composite containing a layer of copper defining an interior surface of the bowl and a layer of a second metal defining an exterior surface of the bowl.

2. The bowl of claim 1 wherein the second metal is stainless steel.

3. The bowl of claim 1 wherein the second metal is aluminum.

4. The bowl of claim 3 wherein the aluminum is anodized.

5. The bowl of claim 1 including a handle.

6. The bowl of claim 5 wherein the handle is integral with the bowl in the form of an outwardly extending flange.

7. The bowl of claim 6 wherein the handle has an aperture formed therethrough for hanging the bowl when not in use.

8. A mixing or beating bowl comprising a bonded composite having a hemispherical shape, the bonded composite containing a layer of copper defining an interior surface of the bowl for contacting the food product to be mixed or beaten and a layer of stainless steel defining an exterior surface of the bowl.

9. The bowl of claim 8 wherein the stainless steel is one selected from 300 series or 400 series stainless steel.

10. The bowl of claim 8 wherein the stainless steel is type 304.

11. The bowl of claim 8 wherein the layer of copper occupies about 25% of the total thickness of the bowl and the stainless steel occupies about 75% of said total thickness.

12. The bowl of claim 11 wherein the total thickness of the bowl is about 0.040 inch.

13. The bowl of claim 8 having at least one handle associated therewith.

14. The bowl of claim 13 wherein the handle is integral with the bowl.

15. The bowl of claim 13 wherein the handle is attached to the bowl.

16. The bowl of claim 8 wherein the hemispherical shape is formed by one of drawing or spinning.

17. A mixing or beating bowl comprising a bonded composite having a hemispherical shape, the bonded composite containing a layer of copper defining an interior surface of the bowl for contacting the food product to be mixed or beaten and a layer of carbon steel coated with enamel defining an exterior surface of the bowl.

18. The bowl of claim 17, wherein the hemispherical shape is formed by one of drawing or spinning.
